(19) United States
(12) Patent Application Publication
(10) Pub. No.: US 2008/0085231 A1
(43) Pub. Date: Apr. 10, 2008

(54) System and method for reducing nitrogen oxides emissions

(76) Inventors: Frederic Vitse, Schenectady, NY (US); Dan Hancu, Clifton Park, NY (US); Benjamin Winkler, Albany, NY (US); Alison Liana Palmatier, Porter Corners, NY (US); Gregg Anthony Deluga, Playa Del Rey, CA (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/543,685

(22) Filed: Oct. 5, 2006

(51) Int. Cl. B01D 53/56

(52) U.S. Cl. 423/239.1

(57) ABSTRACT

A method of removing at least nitrogen oxides from an exhaust gas comprises producing reducing agents including at least hydrogen gas upstream of a conversion catalyst; diverting a portion of the exhaust gas to a location upstream of the conversion catalyst; reacting the reducing agents with nitrogen oxides present in the portion of the exhaust gas to produce a nitrogen-containing compound reducing agent using the conversion catalyst; introducing the nitrogen-containing compound reducing agent upstream of a SCR catalyst; mixing the nitrogen-containing compound reducing agent with a second portion of the exhaust gas upstream of the SCR catalyst; and reacting the nitrogen-containing compound reducing agent with nitrogen oxides present in the second portion of the exhaust gas at the SCR catalyst.

### BACKGROUND

The present disclosure generally relates to systems and methods for reducing nitrogen oxides (NO_{X}) emissions, and more particularly, to systems and methods that employ nitrogen oxides selective catalytic reduction.

An internal combustion engine, for example, transforms fuel such as gasoline, diesel, and the like into work or motive power through combustion reactions. These reactions produce byproducts such as carbon monoxide (CO), unburned hydrocarbons (UHC), and nitrogen oxides (NO_{X}) (e.g., nitric oxide (NO) and nitrogen dioxide (NO₂)). Air pollution concerns worldwide have led to stricter emissions standards for engine systems. As such, research is continually being conducted into systems and methods for reducing nitrogen oxides emissions.

One method of removing nitrogen oxides from an exhaust gas involves a selective catalytic reduction (SCR) process in which nitrogen oxides are broken down into nitrogen and water by a reaction with a reducing agent in the presence of a catalyst. Ammonia is widely used as the reducing agent in the selective catalytic reduction process, because it has excellent catalytic reactivity and selectivity. However, practical use of ammonia has been largely limited to power plants and other stationary applications. More specifically, the toxicity and handling problems (e.g., storage tanks) associated with ammonia has made use of the technology in automobiles and other mobile engines impractical.

Accordingly, a continual need exists for improved systems and methods for reducing nitrogen oxide emissions produced from mobile engine systems.

### BRIEF SUMMARY

Disclosed herein are systems and methods for reducing nitrogen oxides emissions.

In one embodiment, a method of removing at least nitrogen oxides from an exhaust gas comprises producing reducing agents including at least hydrogen gas upstream of a conversion catalyst; diverting a portion of the exhaust gas to a location upstream of the conversion catalyst; reacting the reducing agents with nitrogen oxides present in the portion of the exhaust gas to produce a nitrogen-containing compound reducing agent using the conversion catalyst; introducing the nitrogen-containing compound reducing agent upstream of a SCR catalyst; mixing the nitrogen-containing compound reducing agent with a second portion of the exhaust gas upstream of the SCR catalyst; and reacting the nitrogen-containing compound reducing agent with nitrogen oxides present in the second portion of the exhaust gas at the SCR catalyst.

In one embodiment, a system of removing at least nitrogen oxides from an exhaust gas comprises an exhaust gas source; a SCR catalyst disposed downstream of and in fluid communication with the exhaust gas source; a conversion catalyst disposed upstream of and in fluid communication with the SCR catalyst; and an oxidation catalyst disposed upstream of and in direct fluid communication with the conversion catalyst.

The above described and other features are exemplified by the following Figures and detailed description.

### BRIEF DESCRIPTION OF THE DRAWINGS

Referring to the exemplary drawings wherein like elements are numbered alike in the several Figures:

FIG. 1 is a schematic illustration of an embodiment of a system for reducing at least nitrogen oxides emissions;

FIG. 2 is a schematic illustration of an embodiment of a system for reducing at least nitrogen oxides emissions; and

FIG. 3 is a schematic illustration of an embodiment of a system for reducing at least nitrogen oxides emissions.

### DETAILED DESCRIPTION

Disclosed herein are systems and methods for reducing nitrogen oxides emissions. As will be discussed in greater detail, a reducing agent including at least hydrogen is produced, for example, onboard a mobile engine system, and is catalytically reacted with a portion of the nitrogen oxides (NO_{X}) present in an exhaust stream to produce a nitrogen-containing compound (reducing agent). The remainder of the nitrogen oxide present in the exhaust stream is catalytically reacted with the nitrogen-containing compound to convert the nitrogen oxides to environmentally benign nitrogen gas (N₂).

In the following description, an “upstream” direction refers to the direction from which the local flow is coming, while a “downstream” direction refers to the direction in which the local flow is traveling. In the most general sense, flow through the system tends to be from front to back, so the “upstream direction” will generally refer to a forward direction, while a “downstream direction” will refer to a rearward direction.

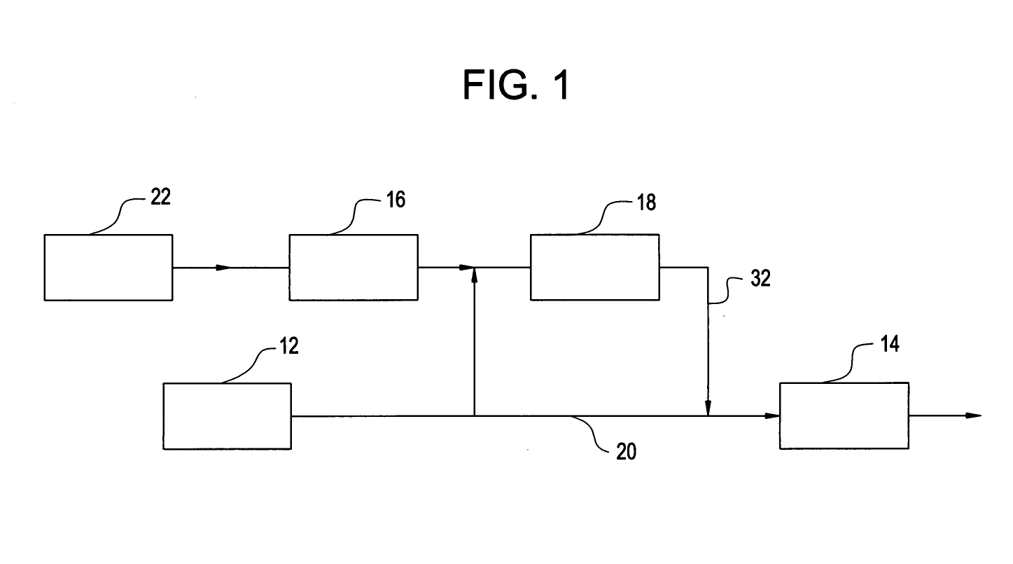

Referring now to FIG. 1, an engine system is illustrated. While the system can be employed in both mobile applications and stationary applications, the system is hereinafter described in relation to mobile applications for ease in discussion, as well as to highlight various advantageous features. The system comprises an exhaust gas source 12, a selective catalytic reduction catalyst 14, an oxidation catalyst 16, and a conversion catalyst 18.

The exhaust gas source 12 includes any source of an exhaust gas that comprises nitrogen oxides (NO_{X}). For example, the exhaust gas source 12 can include, but is not limited to, exhaust gases from spark ignition engines and compression ignition engines. While spark ignition engines are commonly referred to as gasoline engines and compression ignition engines are commonly referred to as diesel engines, it is to be understood that various other types of fuels can be employed in the respective internal combustion engines. Examples of the fuels include hydrocarbon fuels such as gasoline, diesel, ethanol, methanol, kerosene, and the like; gaseous fuels, such as natural gas, propane, butane, and the like; and alternative fuels, such as hydrogen, biofuels, dimethyl ether, and the like; as well as combinations comprising at least one of the foregoing fuels.

The exhaust gas source 12 is disposed upstream of and in fluid communication with the selective catalytic reduction (SCR) catalyst 14 via, for example, an exhaust conduit 20. While the chemistry employed in the SCR catalyst 14 varies depending on the application, the SCR catalyst 14 is selected to be nitrogen oxides (NO_{X}) selective such that in operation a nitrogen-containing compound acts as a reducing agent to reduce the nitrogen oxides to nitrogen gas (N₂). The SCR catalyst 14 is inclusive of an active catalytic material, a substrate material, and an optional support material, which is sometimes referred to as a washcoat layer. Distinctions are not drawn between support materials and active catalytic materials, since in different applications support materials can act as active catalytic materials (e.g., aluminum oxide).

The substrate material of the SCR catalyst 14 is selected to be compatible with the operating environment (e.g., exhaust gas temperatures). Suitable substrate materials include, but are not limited to, cordierite, nitrides, carbides, borides, and intermetallics, mullite, alumina, zeolites, lithium aluminosilicate, titania, feldspars, quartz, fused or amorphous silica, clays, aluminates, titanates such as aluminum titanate, silicates, zirconia, spinels, as well as combinations comprising at least one of the foregoing materials.

With regards to the active catalytic material and/or the optional support material, in one embodiment, the SCR catalyst 14 comprises vanadium oxide (V₂O₅), titanium oxide (TiO₂), tungsten oxide (W₂O₅), or a combination comprising at least one of the foregoing. For example in one embodiment, the SCR catalyst 14 comprises a combination of vanadium oxide (V₂O₅), titanium oxide (TiO₂), tungsten oxide (W₂O₅). In other embodiments, the SCR catalyst 14 comprises a combination of platinum and aluminum oxide (Al₂O₃). In yet other embodiments, the SCR catalyst 14 comprises a composition of M/support material, wherein M is iron (Fe), copper (Cu), silver (Ag), cobalt (Co), gold (Au), palladium (Pd), platinum (Pt), gallium (Ga), indium (In), or a combination comprising at least one of the foregoing, and the support comprises a zeolite, alumina, zirconia, ceria, or a combination comprising at least one of the foregoing. Suitable zeolites include, but are not limited to, mordenites, beta, and pentasil structure zeolites such as ZSM type zeolites, in particular ZSM-5 zeolites, and faujasites (Y-type family).

The conversion catalyst 18 is disposed upstream of and in fluid communication with the SCR catalyst 14. The conversion catalyst 18 can be arranged parallel to the exhaust gas source 12 such that the conversion catalyst 18 is in fluid communication with the SCR catalyst 14 and not in fluid communication with the exhaust gas source 12. In other embodiments, the conversion catalyst 18 is arranged in series with the exhaust gas source 12 such that the conversion catalyst 18 is in fluid communication with the exhaust gas source 12 and the SCR catalyst 14. Further, the conversion catalyst 18 can be disposed in direct fluid communication with the SCR catalyst 14 such that no additional catalyst type devices or mixing devices are disposed in the flow path from conversion catalyst 18 to the SCR catalyst 14.

While the chemistry employed in the conversion catalyst 18 varies depending on the application, the conversion catalyst 18 is selected to at least enable hydrogenation of nitrogen oxides and/or nitrogenation of fuel-based reducing agents that are produced, for example, in the oxidization catalyst 16 to a nitrogen-containing compound capable of acting as a reducing agent. Examples of nitrogen-containing compounds include, but are not limited to, ammonia, amines, and nitrites, as well as combinations comprising at least one of the foregoing. In one embodiment, the nitrogen-containing compound is exclusive of ammonia, that is, the nitrogen-containing compound does not comprise ammonia.

The conversion catalyst 18 is inclusive of an active catalytic material, a substrate material, and an optional support material. Again, distinctions are not drawn between support materials and active catalytic materials. The substrate material is selected to be compatible with the operating environment (e.g., exhaust gas temperatures). Suitable substrate materials include, but are not limited to, those materials discussed above in relation to the SCR catalyst 14. Suitable active catalytic material/support materials include, but are not limited, to noble metals or combinations of noble metals supported on metal oxides or perovskite materials. In one embodiment, suitable catalytic materials include, iron (Fe), cobalt (Co), nickel (Ni), osmium (Os), platinum (Pt), palladium (Pd), iridium (Ir), rhodium (Rh), rhthenium (Ru), silver (Ag), copper (Cu), zinc (Zn), gold (Au), gallium (Ga), indium (In) and a combination comprising at least one of the foregoing. Exemplary metal oxides include, but are not limited to, iron oxide (Fe₂O₃), chromium oxide (CrO₃), magnesium oxide (MgO), cerium oxide (CeO₂), lathanium oxide (La₂O₃), zinc oxide (ZnO), silica (SiO₂) and titanium oxide (TiO₂).

It is to be understood that embodiments are envisioned where the active material/support materials vary across a cross section of the conversion catalyst 18 such that the conversion catalyst can also act to convert (oxidize) nitric oxide (NO) to nitrogen dioxide NO₂. Without wanting to be bound by theory, regulating the ratio of NO to NO₂ can ultimately lead to higher conversions of NO_{X} to nitrogen gas in the SCR catalyst 14 as opposed to systems that do not regulate the ratio of NO to NO₂. In one embodiment, the ratio of NO to NO₂ in the exhaust gas at the SCR catalyst is about 1:0.5 to about 1:1.5, with a ratio of 1:1 particularly desired in some applications.

The oxidation catalyst 16 is disposed upstream of and in fluid communication with the conversion catalyst 18. The oxidation catalyst 16 can be arranged parallel to the exhaust gas source 12 such that oxidation catalyst 16 is in fluid communication with the conversion catalyst 18 and the SCR catalyst 14, but not in fluid communication with the exhaust gas source 12. In other embodiments, the oxidation catalyst 16 is arranged in series with the exhaust gas source 12 such that the oxidation catalyst 16 is in fluid communication with the exhaust gas source 12 and the SCR catalyst 14. Further, the oxidation catalyst 16 can be disposed in directed fluid communication with the conversion catalyst 18 such that no additional catalysts type devices or mixing devices are disposed in the flow path from the oxidation catalyst 16 to the conversion catalyst 18.

The oxidation catalyst 16 acts to breakdown fuel from a fuel source 22 into smaller molecules. For example, the fuel can be broken down into hydrogen, carbon monoxide, alkanes, alkenes, acetylenes, aromatics, naphthalenes, oxygenates, and the like. Stated another way, the oxidation catalyst 16 acts to breakdown fuel from a fuel source 22 into reducing agents including at least hydrogen. Suitable fuels include, but are not limited to those discussed above in relation to internal combustion engines. In one embodiment, examples of the fuels include hydrocarbon fuels such as gasoline, diesel, ethanol, methanol, kerosene, and the like. The fuel from the fuel source 22 can be delivered to the oxidation catalyst 16 by any suitable means (e.g., a fuel pump).

While the chemistry of the oxidation catalyst 16 varies depending on the application, the oxidation catalyst 16 comprises a material that assists in converting hydrocarbon compounds into reducing agents that include at least hydrogen gas. Other suitable fuel-based reducing agents that may be produced include, but are not limited to, alkanes, alkenes, acetylenes, aromatics, naphthalenes, and oxygenates. The oxidation catalyst 16 may sometimes be referred to as a fuel processor, a reformer, an oxidation combustor, and the like. In operation, the fuel can be converted to a gas comprising hydrogen using steam reforming, auto-thermal reforming, partial-oxidation, or other known processes.

The oxidation catalyst 16 is inclusive of an active catalytic material, a substrate material, and an optional support material. Distinctions are not drawn between support materials and active catalytic materials. The substrate material is selected to be compatible with the operating environment (e.g., exhaust gas temperatures). Suitable substrate materials include, but are not limited to, those materials discussed above in relation to the SCR catalyst 14. Suitable active catalytic material/support materials include, but are not limited to, noble metal and metal oxides. Exemplary noble metals include combinations of rhodium (Rh) and platinum (Pt). Exemplary metal oxides include, but are not limited to, aluminum oxide (Al₂O₃), zinc oxide (ZnO), silica (SiO₂), and titanium oxide (TiO₂).

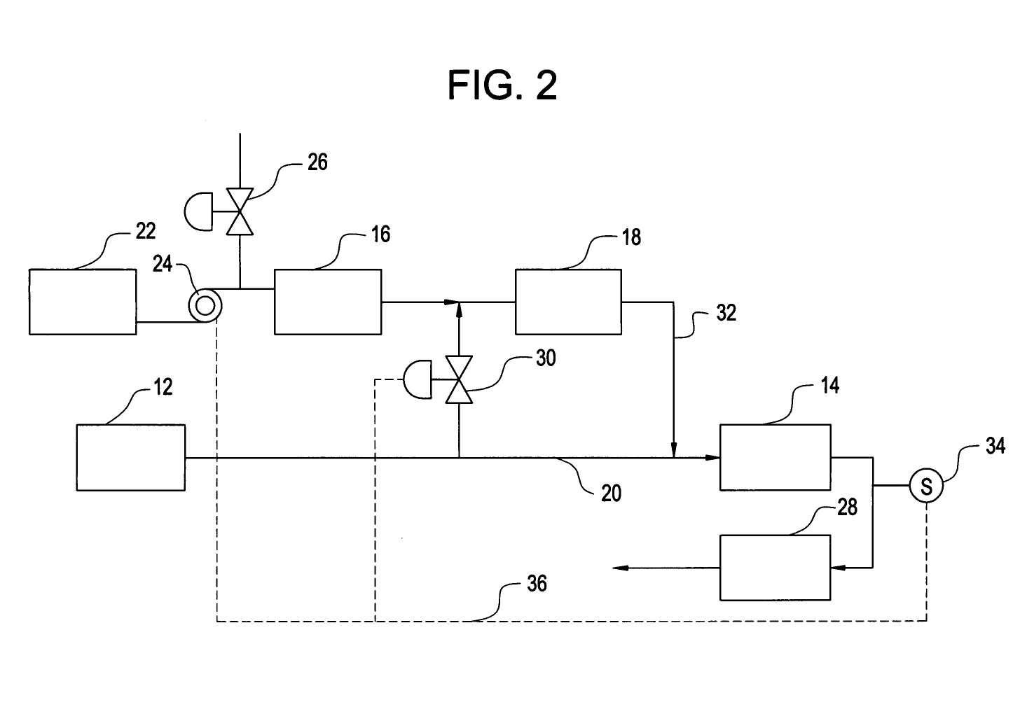

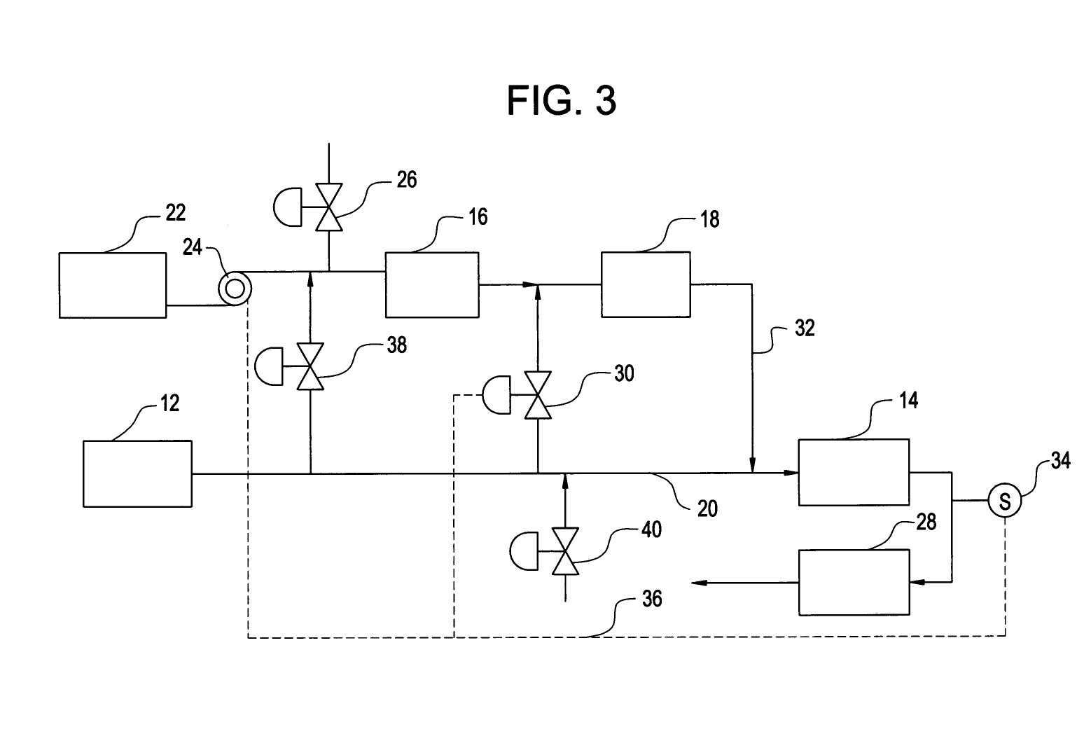

Referring now to FIGS. 2-3, various optional features that may be added to system are illustrated. For example, an optional fuel pump 24 may be employed. Additionally, air or any other suitable oxygen source may periodically be introduced upstream of the oxidation catalyst 16 via for example an optional valve 26 such that during operation the fuel can react with oxygen on the catalyst to produce, among other things, hydrogen gas (H₂).

An optional deep oxidation catalyst 28 is disposed downstream of and in fluid communication with the SCR catalyst 14. The deep oxidation catalyst 28 is configured to at least enable oxidation of carbon monoxide to carbon dioxide. The deep oxidation catalyst 16 is inclusive of an active catalytic material, a substrate material, and an optional support material. The substrate material is selected to be compatible with the operating environment (e.g., exhaust gas temperatures). Suitable substrate materials include, but are not limited to, those materials discussed above in relation to the SCR catalyst 14. Suitable active catalytic material/support materials include, but are not limited, to noble metal and metal oxides. Exemplary noble metals include combinations of rhodium (Rh), platinum (Pt) and palladium (Pd). Exemplary metal oxides include, but are not limited to, aluminum oxide (Al₂O₃), zinc oxide (ZnO), and titanium oxide (TiO₂).

An optional by-pass valve 38 is disposed in fluid communication with the exhaust gas source 12 and the oxidation catalyst 16. More particularly, during operation, exhaust gas from the exhaust gas source 12 can be diverted to a location upstream of the oxidation catalyst 16, where it may be mixed with fuel from the fuel source 22. Without wanting to be bound by theory, by diverting a portion of the exhaust gas upstream of the oxidation catalyst 16, a greater degree of flexibility in the chemistry of the oxidation catalyst 16 may be obtained compared to systems where the exhaust gas is not diverted. Stated another way, nitrogen oxides present in the exhaust gas can act as a source of oxygen for reactions occurring in the oxidation catalyst 16. In other embodiments, fuel from, for example, fuel source 22 may be introduced into the exhaust conduit 20 via optional valve 40. The fuel introduced into the exhaust conduit can act as a reducing agent in the SCR 14. Additionally, the injected fuel can promote partial oxidation reactions in the SCR 14.

It is to be understood that while the SCR catalyst 14, the oxidation catalyst 16, the conversion catalyst 18, and the deep oxidation catalyst 28 are illustrated as being separate devices in the figure, embodiments are envisioned where several different types of catalysts are disposed on the same substrate or alternatively disposed in the same housing. In other embodiments, each catalyst can be disposed on separate substrates that are spaced apart from each other, but are disposed in a single housing. Additionally, various other optional devices not illustrated may also be employed including, but not limited to, an additional sensor disposed downstream of the deep oxidation catalyst 28.

In operation, exhaust from the exhaust gas source 12 travels through the exhaust conduit 20. A portion of the exhaust gas in the exhaust gas conduit is diverted, for example, by the optional valve 30 such that the portion of the exhaust gas is disposed upstream of the conversion catalyst 18 and downstream of the oxidation catalyst 16. At the same time, hydrogen gas and/or other fuel-based reducing agents produced by the oxidation catalyst 16 mix with the portion of the exhaust gas upstream of the conversion catalyst 18. In the conversion catalyst 18, the hydrogen and/or other fuel-based reducing agents are reacted with nitrogen oxides present in the portion of the exhaust gas to convert the nitrogen oxides to a nitrogen-containing compound capable of acting as a reducing agent. Optionally, a portion of nitric oxide present in the exhaust gas may also be converted to nitrogen dioxide in the conversion catalyst 18 as discussed above.

The nitrogen-containing compound produced from the conversion catalyst 18, as well as any optionally produced nitrogen dioxide is directed to the SCR catalyst 14. More particularly, an effluent stream 32 from the conversion catalyst 18 is introduced at a location upstream of the SCR catalyst 14 such that it mixes with exhaust gas from the exhaust gas source 12, that is, the portion of exhaust gas that was not diverted to the conversion catalyst 18. In the SCR catalyst 14, nitrogen oxides react with the nitrogen-containing compound to produce nitrogen gas. Optimally, the nitrogen oxides and the nitrogen-containing compound are reacted at a stoichiometric ratio. However, embodiments are envisioned where excess nitrogen-containing compounds are feed to the SCR catalyst 14.

While the diversion of exhaust gas can be based on variables such as time, engine loads, and the like, in one embodiment various sensors may optionally be employed to provide active feedback control. For example, an optional NO sensor 34 can be disposed downstream of and in fluid communication with the SCR catalyst 14 to measure NO slip past the SCR catalyst 14. In one embodiment, the sensor 34 is disposed in operable communication with the valve 30 and the fuel pump 24 such that exhaust gas can be diverted and hydrogen can be produced to produce the nitrogen-containing compounds employed in reducing nitrogen oxides to nitrogen gas in the SCR catalyst 14. The operable communication loop of the sensor 34 with the valve 30 and the fuel pump 24 is illustrated as dotted line 36.

Advantageously, the onboard production of nitrogen-containing reductants for reducing nitrogen oxides to nitrogen gas eliminates the need of on-board reductant storage, thereby enabling a practical means of reducing nitrogen oxides in mobile applications. Further, the treatment of part of the exhaust steam at the SCR catalyst, instead of the entire exhaust stream allows for a significant reduction of the fuel penalty for the production of reducing agents.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of removing at least nitrogen oxides from an exhaust gas, the method comprising:
producing reducing agents including at least hydrogen gas upstream of a conversion catalyst;
diverting a portion of the exhaust gas to a location upstream of the conversion catalyst;
reacting the reducing agents with nitrogen oxides present in the portion of the exhaust gas to produce a nitrogen-containing compound reducing agent using the conversion catalyst;
introducing the nitrogen-containing compound reducing agent upstream of a SCR catalyst;
mixing the nitrogen-containing compound reducing agent with a second portion of the exhaust gas upstream of the SCR catalyst; and
reacting the nitrogen-containing compound reducing agent with nitrogen oxides present in the second portion of the exhaust gas at the SCR catalyst.

2. The method of claim 1, further comprising reacting carbon monoxide exiting the SCR catalyst to carbon dioxide at a deep oxidation catalyst located downstream of the SCR catalyst.

3. The method of claim 1, wherein the SCR catalyst comprises vanadium oxide (V₂O₅), titanium oxide (TiO₂), and tungsten oxide (W₂O₅) or a combination comprising at least one of the foregoing.

4. The method of claim 1, wherein the SCR catalyst comprises a combination of platinum and aluminum oxide (Al₂O₃).

5. The method of claim 1, wherein the SCR catalyst comprises a composition of M/support material, wherein M is iron (Fe), copper (Cu), silver (Ag), cobalt (Co), gold (Au), palladium (Pd), platinum (Pt), gallium (Ga), indium (In), or a combination comprising at least one of the foregoing, and wherein the support material is selected from the group consisting of a zeolite, alumina, zirconia, ceria, and a combination comprising at least one of the foregoing.

6. The method of claim 5, wherein the zeolite is selected from the group consisting of mordenites, beta, and pentasil structure zeolites.

7. The method of claim 1, wherein the nitrogen-containing compound reducing agent is selected from the group consisting of ammonia, amines, nitriles, and combinations comprising at least one of the foregoing.

8. The method of claim 1, wherein the nitrogen-containing compound reducing agent is exclusive of ammonia.

9. The method of claim 1, further comprising converting a portion of nitrogen oxide present in the portion of the exhaust gas to nitrogen dioxide using the conversion catalyst.

10. The method of claim 1, wherein the conversion catalyst comprises a catalyst material selected from the group consisting of iron (Fe), cobalt (Co), nickel (Ni), osmium (Os), platinum (Pt), palladium (Pd), iridium (Ir), rhodium (Rh), rhthenium (Ru), silver (Ag), copper (Cu), zinc (Zn), gold (Au), gallium (Ga), indium (In) and a combination comprising at least one of the foregoing.

11. The method of claim 1, wherein the reducing agent further comprises a reducing agent selected from the group consisting of alkanes, alkenes, acetylenes, aromatics, naphthalenes, oxygenates, and a combination comprising at least one of the foregoing.

12. A system of removing at least nitrogen oxides from an exhaust gas, the system comprising:
an exhaust gas source;
a SCR catalyst disposed downstream of and in fluid communication with the exhaust gas source;
a conversion catalyst disposed upstream of and in fluid communication with the SCR catalyst; and
an oxidation catalyst disposed upstream of and in direct fluid communication with the conversion catalyst.

13. The system of claim 12, wherein the exhaust gas source is an internal combustion engine.

14. The system of claim 12, wherein the SCR catalyst comprises a combination of vanadium oxide (V₂O₅), titanium oxide (TiO₂), and tungsten oxide (W₂O₅).

15. A system of removing at least nitrogen oxides from an exhaust gas, the system comprising:
an exhaust gas source, wherein the exhaust gas source is a spark ignition engine or a compression ignition engine;
a SCR catalyst disposed downstream of and in fluid communication with the exhaust gas source;
a conversion catalyst disposed upstream of and in direct fluid communication with the SCR catalyst, wherein the conversion catalyst is capable of converting nitrogen oxides in the presence of a reducing agent comprising at least hydrogen gas to a nitrogen-containing compound reducing agent from; and
an oxidation catalyst disposed upstream of and in direct fluid communication with the conversion catalyst, wherein the oxidation catalyst is capable of converting a hydrocarbon fuel into a reducing agent comprising at least hydrogen gas.

16. The system of claim 15, wherein the SCR catalyst comprises vanadium oxide (V₂O₅), titanium oxide (TiO₂), and tungsten oxide (W₂O₅) or a combination comprising at least one of the foregoing.

17. The system of claim 15, wherein the SCR catalyst comprises a combination of platinum and aluminum oxide (Al₂O₃).

18. The system of claim 15, wherein the SCR catalyst comprises a composition of M/support material, wherein M is iron (Fe), copper (Cu), silver (Ag), cobalt (Co), gold (Au), palladium (Pd), platinum (Pt), gallium (Ga), indium (In), or a combination comprising at least one of the foregoing, and wherein the support material is selected from the group consisting of a zeolite, alumina, zirconia, ceria, and a combination comprising at least one of the foregoing.

19. The system of claim 15, wherein the zeolite is selected from the group consisting of mordenites, beta, and pentasil structure zeolites.

20. The system of claim 15, wherein the conversion catalyst comprises a catalyst material selected from the group consisting of iron (Fe), cobalt (Co), nickel (Ni), osmium (Os), platinum (Pt), palladium (Pd), iridium (Ir), rhodium (Rh), rhthenium (Ru), silver (Ag), copper (Cu), zinc (Zn), gold (Au), gallium (Ga), indium (In) and a combination comprising at least one of the foregoing.
